(19) United States
(12) Patent Application Publication
(10) Pub. No.: US 2009/0224208 A1
(43) Pub. Date: Sep. 10, 2009

(54) Gas Burner With Optimized Nozzle Arrangement

(75) Inventors: Silke Wodberg, Gevelsberg (DE); Evgeni Gorval, Dortmund (DE); Joachim Johanning, Oberhausen (DE)

Correspondence Address: MARSHALL & MELHORN, LLC, FOUR SEAGATE - EIGHTH FLOOR, TOLEDO, OH, 43604, US

(73) Assignee: UHDE GMBH, DORTMUND (DE)

(21) Appl. No.: 12/223,558

(22) PCT Filed: Jan. 20, 2007
(86) PCT No.: PCT/EP2007/000483

§ 371 Date: Oct. 14, 2008

(30) Foreign Application Priority Data
Feb. 3, 2006 (DE) 10 2006 005 386.9

(51) Int. Cl. C01B 3/02; F23D 11/38; F24H 3/00

(52) U.S. Cl. 252/373; 239/543; 126/116 R

(57) ABSTRACT

The invention relates to a gas burner for burning fuel gases with oxygen, said gas burner comprising a primary gas nozzle (6) and secondary gas nozzles (5) which are connected to a common central feed line (3). In this case, the non-horizontal openings (8), directed obliquely downwards, of the primary gas nozzle are oriented in such a way that the gas jet of said primary gas nozzle is directed towards a point of a centre line (10) between two respective secondary gas nozzles, and the centre line is defined as an imaginary line which runs parallel to the rotation axis of the primary gas nozzle and centrally between two adjacent secondary gas nozzles.

The invention relates to a gas burner for combustible gas burned with the aid of oxygen, the said burner being equipped with a primary gas nozzle and secondary gas nozzles, both types connected to a common central feed line. The non-horizontal openings of the primary gas nozzle are inclined downwards in such a manner that the gas jet points towards a position located on a centre-line between two secondary gas nozzles, the centre-line being defined as a theoretical line that is located parallel to the axis of rotation of the primary gas nozzle and in the middle of two neighboring secondary gas nozzles.

According to the state-of-the-art technology, burning of combustible gases or gas mixtures is carried out in multi-stage gas burners. In a first combustion stage, the combustible gas is fed via primary gas nozzles into the combustion zone or furnace chamber, mixed with oxygen or oxygen-bearing gas and then burned. In order to ensure post-combustion of the gas components not completely burned in the first combustion stage, secondary gas nozzles are arranged downstream in addition to the primary gas nozzles and inject a further portion of combustible gas into the combustion zone or furnace chamber so that the oxidizable components undergo complete oxidation or combustion in the gas mixture stream passing by.

This type of gas burner is used, for example, in industrial-scale synthesis gas furnaces with ceiling-mounted firing system for the production of H₂ and CO. A plurality of reaction tubes filled with a catalyst penetrate the furnace chamber fired by the ceiling-mounted system. The reaction tubes placed in a corridor-type arrangement are heated by multi-stage gas burners heating the said corridor space. The reaction tubes filled with catalyst are penetrated by a stream of feed gas normally with a low hydrocarbon, such as methane, propane, butane or a mixture of these hydrocarbons. It is crucial for the process that the reaction tubes be uniformly heated. In sections filled with catalyst that do not reach the required reaction temperature, no conversion takes place or merely at a reduced level so that the overall yield of the synthesis process declines. If local hotspots occur, they may cause damage to the material.

It is true that reaction tubes of the same type used in synthesis gas furnaces exhibit different conversion rates, although very high Reynolds figures are achieved in the areas of primary and secondary gas nozzles and consequently, high turbulence stream dynamics is ensured.

Hence, the objective of the invention is to provide an improved process and a gas burner that permits as uniform a thermal load as possible of the reaction tubes.

The objective of the invention is achieved in accordance with the main claim and sub-claims which reflect the improved design criteria and reveal a gas burner for burning of combustible gases or mixtures of combustible gases, together with oxygen or oxygen-bearing gas mixtures, the said gas burner being equipped with at least one primary gas nozzle and at least two secondary gas nozzles, both types connected to a common central feed line. The secondary gas nozzles are arranged essentially in a radial and symmetrical manner around the primary gas nozzle. At least one component for stream control is installed upstream of the primary gas nozzle which has a plurality of openings arranged radially, a certain number thereof being designed as horizontal openings, the axis of which is perpendicular to the axis of rotation of the primary gas nozzle and penetrates the wall of the said primary gas nozzle, and the other number of the radially arranged openings being designed as non-horizontal type, whose axis is inclined towards the axis of rotation of the primary gas nozzle in the main stream direction.

In this context, the term “axis of an opening” always refers to the perpendicular to the free cross-sectional surface of this opening, irrespective of the fact whether the cross-sectional surface is of circular or any other shape. In the case of circular cross-sectional surfaces, you further have to take it that—regarding the position of the axis on the cross-sectional surface—this axis passes through the centre-point and in the case of non-circular cross-sectional surfaces, the said axis passes through the geometrical centre-point of that cross-sectional surface.

The criterion crucial for the gas burner specified in the invention is that the axes of any non-horizontal opening are oriented towards a point on the centre-line located between each pair of secondary gas nozzles and that the centre-line is defined as a theoretical line located parallel to the axis of rotation of the primary gas nozzle and in the middle between two neighboring secondary gas nozzles. In an ideal configuration, the number of non-horizontal openings is identical with the number of secondary gas nozzles. A system of improved design consists in the arrangement of the secondary gas nozzles downstream of the primary gas nozzle.

It is possible to optimize the gas burner by providing one or several vertical openings for the primary gas nozzle so that the combustible gas can flow towards the axis of rotation upon installing the unit in the burner.

The gas burner head or the primary gas nozzle, respectively, are subject to wear and thus wear parts must be changed regularly. An optimized variant of this device consists in a detachable nozzle head of the primary gas nozzle, the said head having non-horizontal openings and the nozzle head being designed in such a manner or equipped with such members that permit an orientation of the axis of each non-horizontal opening towards a point located on the centre-line between two secondary gas nozzles. The specialist skilled in the art has a variety of design possibilities for positioning the openings of the primary gas nozzle in relation to the secondary gas nozzles. For this purpose, the central pipe nozzle may, for example, be fixed by means of a flange and the bore positions be such that a mismatch of the openings is avoided. Moreover, the gas burner head can be attached to the central pipe by means of a screwed union, the final position being adjusted by a spring-loaded ball, a counter-splint or counter-bolt. Other types of unions are feasible, too.

The gas burner can be further enhanced by providing a component upstream of the primary gas nozzle for stream guidance, either in direct contact with the nozzle head or attached to it.

The present invention also encompasses a reforming furnace for the production of hydrogen and carbon monoxide-bearing synthesis gas, the said furnace being equipped with a gas burner that complies with one of the design variants described above. Furthermore, the invention covers a process for the production of hydrogen and carbon monoxide-bearing synthesis gas, using a reforming furnace with a gas burner of the type outlined in the above-mentioned design variants.

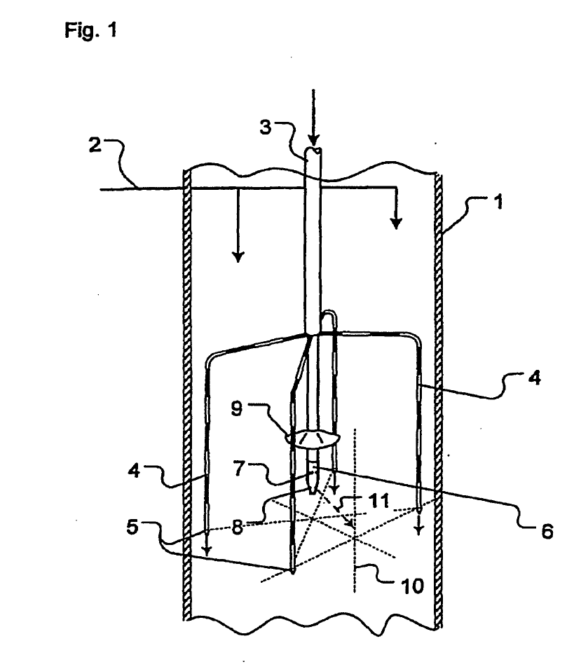

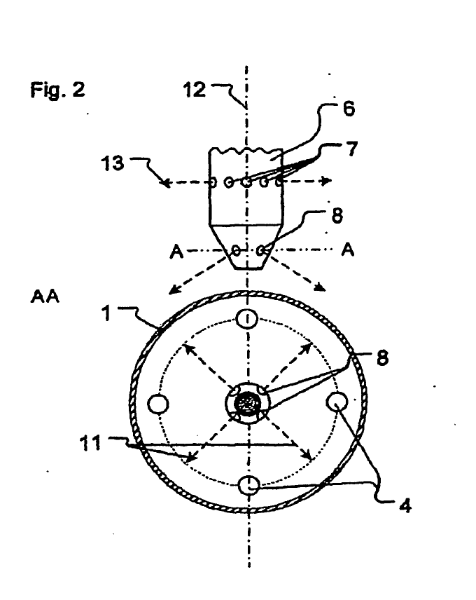

FIG. 1 and FIG. 2 illustrate a typical example of the gas burner in accordance with the invention, the invention not being restricted to the design example shown there. FIG. 1 shows the perspective view of the gas burner in accordance with the invention and the arrangement of the primary and secondary gas nozzles. The burner duct 1 is used for feeding oxygen or an oxygen-bearing gas mixture via duct 2. The central combustible gas line 3 installed in the middle of the burner duct 1 has four smaller branch lines for combustible gas 4 required to feed the secondary gas nozzles 5. The said combustible gas lines 4 are essentially installed symmetrically and routed radially from the central combustible gas line 3 towards the external side and then downwards in an elbow parallel to the wall of burner duct 1. The ends of these four combustible gas lines are connected to the secondary gas nozzles.

The central combustible gas line 3 is routed without major deflections to the primary gas nozzle 6. FIG. 1 depicts a sketch of, and FIG. 2 the details of the horizontal openings 7 arranged in a circumference on the primary gas nozzle as well as the non-horizontal openings 8 oriented downwards. Stream deflector 9 is located above the primary gas nozzle 6, the deflector being shaped as umbrella-type deflector shown in this example.

Furthermore, FIG. 1 shows a centre-line 10 in the form of a dashed line located between two combustible gas lines 4 pointing downwards. The centre-line 10 runs in parallel to the central combustible gas line 3. The perpendicular to the non-horizontal openings exactly points to the centre-line 10. This correlation was merely sketched for a non-horizontal opening 8 but it analogously applies to all of the other non-horizontal openings 8, too. The direction of the combustible gas stream from the non-horizontal opening 8 is shown as a dashed arrow 11.

FIG. 2 shows a scaled up detail view of the primary gas nozzle and the AA section in the area of the non-horizontal openings 8. The upper part of the said view reveals that the gas burner jet originating from the primary gas nozzle via the horizontal openings 7 is perpendicular to the axis of rotation 12 of the central combustible gas line 3. The said burner jet is shown as a dashed arrow 13, the dashed arrow 4 indicating the flow direction of the gas burner gases which are piped via the non-horizontal openings 8 to the burner duct 1.

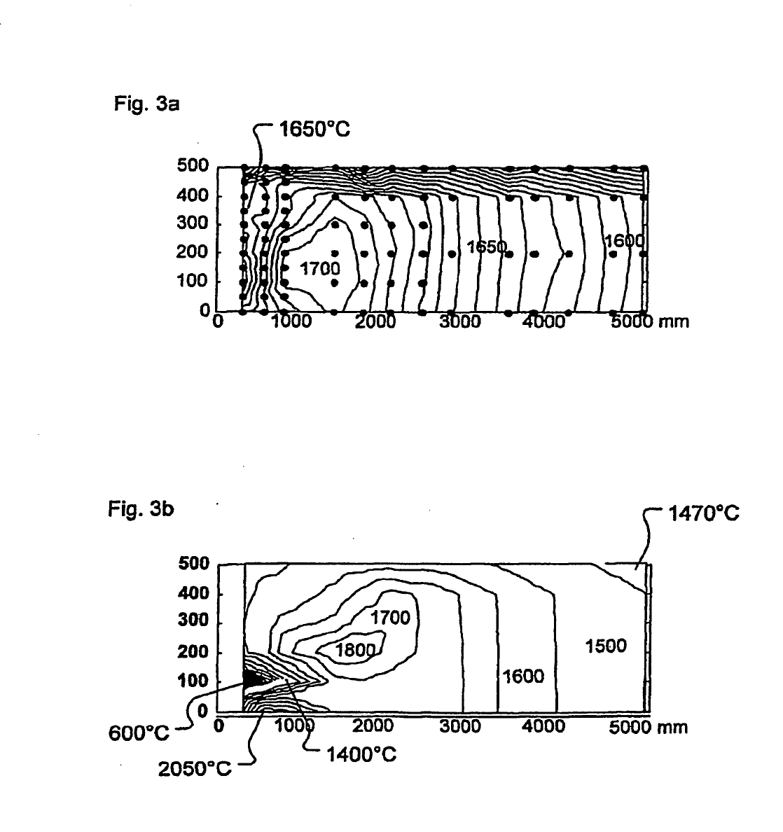

The temperature gradient in the area of the primary gas nozzle was calculated with the help of a simulation. FIG. 3a shows the deployment of the inventive gas burner as described in connection with FIG. 1 and FIG. 2. The X-axis depicts the distance from the primary gas nozzle in terms of mm and the diagram surface areas reflect the ranges with the same temperature.

FIG. 3b shows an example of comparison with the axis of the non-horizontal openings pointing towards the secondary gas nozzles. A surprisingly significant difference between the example of comparison and the inventive device became obvious. The temperature gradient of the measurement of comparison showed sections with a temperature of more than 2050° C. and one section located near the primary gas nozzle and with a temperature as low as approx. 600° C., i.e. a very incomplete combustion taking place there. This sort of problem could not be foreseen because the area of the primary gas nozzle exhibited highly turbulent stream dynamics with an ideal mixing process. Apart from the above-mentioned effects on neighboring reaction tubes, if any, the combustion that was far from being optimum resulted in higher concentrations of NOₓ, N₂O and CO in the waste gas.

The temperature gradient of the inventive device, however, was surprisingly homogeneous or in other words, uniformly graded as shown in FIG. 3a. There were neither hotspots nor sections with poor combustion. This fact permits an optimum heating of neighboring reaction tubes and consequently a more complete combustion.

1. A gas burner for burning of combustible gases or mixtures of combustible gases, together with oxygen or oxygen-bearing gas mixtures, the said burner encompassing at least one primary gas nozzle and at least two secondary gas nozzles, both types connected to a common central feed line, the secondary gas nozzles being arranged essentially in a radial and symmetrical manner around the primary gas nozzle, and furthermore at least one component for stream control installed upstream of the primary gas nozzle which has a plurality of openings arranged radially, a certain number of the openings being designed as horizontal openings, the axis of which is perpendicular to the axis of rotation of the primary gas nozzle and penetrates the wall of the said primary gas nozzle, and the other number of the radially arranged openings being designed as non-horizontal type, whose axis is inclined towards the axis of rotation of the primary gas nozzle in the main stream direction, wherein
the axis of any non-horizontal opening is oriented towards a point on the centre-line located between each pair of secondary gas nozzles, and that the centre-line is defined as a theoretical line located parallel to the axis of rotation of the primary gas nozzle and in the middle between two neighbouring secondary gas nozzles.

2. The gas burner according to claim 1, wherein the number of non-horizontal openings is identical with the number of secondary gas nozzles.

3. The gas burner according to claim 1, wherein the primary gas nozzle has one or several vertical openings.

4. The gas burner according to claim 1, wherein the secondary gas nozzles are arranged downstream of the primary gas nozzle.

5. The gas burner according to claim 1, wherein the primary gas burner has a detachable nozzle head having non-horizontal openings and the nozzle head being designed in such a manner or equipped with such members that permit an orientation of the axis of each non-horizontal opening towards a point located on the centre-line between two secondary gas nozzles.

6. The gas burner according to claim 5, wherein the nozzle head is screwed to the combustible gas line.

7. The gas burner according to claim 5, wherein the wall of the nozzle head and the combustible gas feeder line have at least one bore accommodating a counter-bolt or counter-splint.

8. The gas burner according to claim 5, wherein the nozzle head is attached to the end of the combustible gas line by means of a flange.

9. The gas burner according to claim 1, wherein a component is installed upstream of the primary gas nozzle for stream guidance, either in direct contact with the nozzle head or attached to it.

10. Reforming furnace for the production of hydrogen and carbon monoxide-bearing synthesis gas, comprising a gas burner according to claim 1.

11. Process for the production of hydrogen and carbon monoxide-bearing synthesis gas, wherein a reforming furnace equipped with a gas burner according to claim 1 is utilized to produce the gas.
